(19) United States
(12) Patent Application Publication
(10) Pub. No.: US 2003/0175588 A1
(43) Pub. Date: Sep. 18, 2003

(54) Cathode compositions, cathodes, methods of producing cathodes and lithium secondary batteries including the same

(76) Inventor: Dong Zhang, Oklahoma City, OK (US)

Correspondence Address: William B. Miller, Kerr-McGee Corpoaration, 123 Robert S. Kerr Avenue, Oklahoma City, OK, 73102, US

(21) Appl. No.: 10/097,875

(22) Filed: Mar. 14, 2002

(51) Int. Cl. H01M 4/62; H01M 4/50; H01M 4/52; H01M 4/60; H01M 4/66; B05D 5/12

(52) U.S. Cl. 429/217; 429/231.3; 429/231.1; 429/223; 429/224; 429/231.6; 429/231.2; 429/213; 429/245; 429/232

(57) ABSTRACT

The present invention provides improved cathode compositions, improved cathodes, methods of producing improved cathodes including the cathode compositions and improved lithium secondary batteries. The cathode compositions of the invention are comprised of a particulate cathode active material, a particulate conductive substance and a binder formed of small fibers that are substantially homogeneously dispersed throughout the cathode composition but which do not encapsulate to any meaningful degree the particulate conductive substance and cathode active materials, so that a lithium secondary battery including the cathode composition has an improved charge-discharge rate capability and improved power and energy densities.

### BACKGROUND OF THE INVENTION

1. Field of the Invention

The present invention relates to lithium secondary batteries and more particularly, to improved cathode compositions and cathodes for lithium secondary batteries.

2. Description of the Prior Art

In recent years, lithium secondary batteries having relatively high charge-discharge rates have been developed which are comprised of a cathode active material formed of lithium composite oxides such as lithium manganese oxide and an anode formed of a carbonaceous material, lithium metal or a lithium alloy.

The charge-discharge rate capability for such rechargeable lithium secondary batteries is very important for many applications including their applications to electric vehicles which combine an internal combustion engine with an electric motor powered by rechargeable batteries. The primary function of the battery-powered electric motor is to provide power during acceleration and hill climbing and to recharge the batteries during braking. That is, during braking the electric motor becomes a generator which uses the kinetic energy of the vehicle to recharge the batteries.

In these applications, the battery's suitability and usefulness are improved when the battery's internal resistance is decreased. The internal resistance of a battery consists of the sum of the resistances created by the anode, the electrolyte and the cathode in the battery. As related in U.S. Pat. No. 5,714,282 to Tagawa, cathodes had been made by press forming battery active material powder with a powder binder such as polytetrafluoroethylene (PTFE) powder, but this technique did not lend itself to the thin cathodes with large surface areas and high charge/discharge rate capabilities, power and energy densities that were desired. An alternative suggested method was to prepare the cathode by coating a current collector in the form of a metal film with a slurry of a particulate cathode active material, such as lithium manganese oxide, and a binder such as polyvinylidene fluoride in an organic solvent such as N-methylpyrrolidone. After coating the current collector with the slurry, the N-methylpyrrolidone solvent was evaporated and the coating dried. This method produced a thin electrode with a large surface area, but possessed the disadvantage that the particles of the cathode active material and any particulate conductive substance which may be included with the cathode active material were at least partially encapsulated by the electrically insulating polyvinylidene fluoride. The encapsulation of actives by the PVDF binder causes very poor conductivity and a substantial voltage drop at high discharge rates. Furthermore, the N-methylpyrrolidone solvent is toxic and may be difficult to remove completely because of its high boiling point, with attendant adverse effects on the battery. Tagawa proposed a coating paste of an aqueous dispersible material from which the water would be evaporated, but as recognized in U.S. Pat. No. 6,153,332 to Nishida et al. and as is well appreciated by those skilled in the art, the reactivity of water with lithium-based materials can likewise cause an undesirable deterioration of the battery's performance.

### SUMMARY OF THE INVENTION

The present invention provides improved cathode compositions and cathodes, methods of producing improved cathodes utilizing the cathode compositions and lithium secondary batteries having improved high charge-discharge rate capabilities and high power and energy densities.

A cathode composition for a lithium secondary battery of the present invention is comprised of a particulate cathode active material, a particulate conductive substance and a binder formed of small fibers that are substantially homogeneously dispersed throughout the cathode composition and which provide sufficient cohesiveness and integrity to the cathode as formed, but which do not encapsulate to any meaningful degree the particulate conductive substance and cathode active materials. This results in the cathode active material particles and the conductive substance particles being in contact with each other and with other adjacent battery parts in contact with the cathode composition whereby the battery has an improved charge-discharge rate capability, power density and energy density. The particulate cathode active material in the cathode composition is preferably lithium manganese oxide and the preferred particulate conductive substance is a mixture of acetylene black and graphite. The binder formed of small fibers is preferably polytetrafluoroethylene.

A cathode of this invention for a lithium secondary battery is comprised of the cathode composition described above and a current collector. The current collector is preferably formed of aluminum foil and the cathode composition is preferably formed into a layer on the current collector.

A process of this invention for producing a cathode for a lithium secondary battery comprised of a current collector and the cathode composition described above is basically comprised of the steps of dry mixing the cathode active material particles and the conductive substance particles with the binder fibers to thereby form a paste and then forming the paste into a pressed layer on the current collector at a temperature below the melting point of the binder. The paste attaches to the current collector. If desired, the paste can be formed into a pressed layer apart from the current collector whereby the cathode composition is not attached to the current collector, and is in contact with the current collector after the battery containing the cathode is assembled.

A lithium secondary battery of this invention is comprised of a cathode including the cathode composition of this invention and a current collector in contact therewith, an anode formed of a carbonaceous material that can be doped/undoped with lithium ions, a lithium metal or a lithium alloy and a non-aqueous liquid or solid electrolyte.

### BRIEF DESCRIPTION OF THE DRAWINGS

FIG. 1 is a schematic cross-sectional view of a lithium secondary battery of this invention in the form of a coin cell.

FIG. 2 is a current and voltage profile for testing the rate capability of lithium composite oxides.

FIG. 3 is a current and voltage profile for the pulse test method for evaluating charge-discharge rate capability.

FIG. 4 is a current and voltage profile for the relaxation test method described in Example 3.

FIG. 5 is a comparison of the slurry coating method used in Comparative Example 2 and the paste method of the present invention used in Examples 1 and 3.

FIG. 6 is a comparison of the slurry coating method used in Comparative Example 3 and the paste method of the present invention used in Example 2.

FIG. 7 is a scanning electron micrograph (section view) of the cathode composition prepared according to the present invention.

FIG. 8 is a scanning electron micrograph (section view) of the cathode layer on the current collector, as prepared by conventional methods.

### DESCRIPTION OF PREFERRED EMBODIMENTS

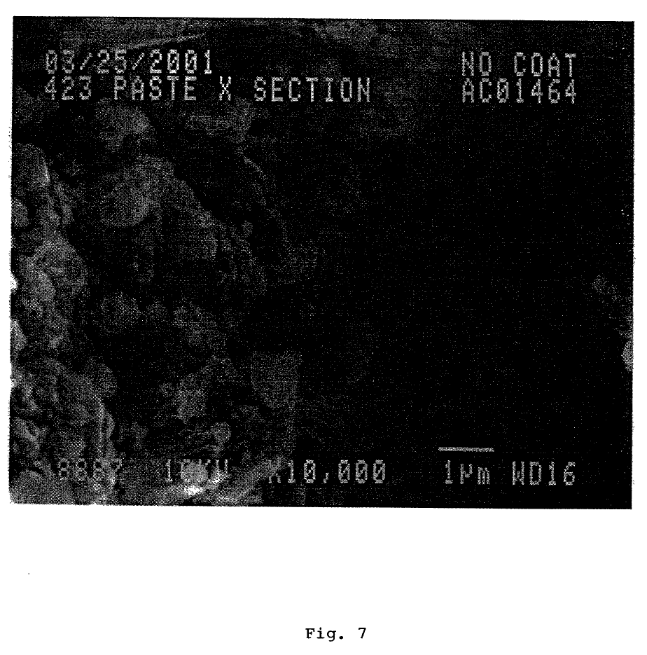

As mentioned, the improved cathode composition for a lithium secondary battery of the present invention is comprised of a particulate cathode active material, a particulate conductive substance and a binder. The binder is formed of small fibers that are substantially homogeneously dispersed throughout the cathode composition but which do not encapsulate to any meaningful degree the particulate conductive substance and cathode active materials, so that the cathode active material particles and the conductive substance particles are in contact with each other and with other adjacent battery parts in contact with the cathode composition. The Scanning Electron Microscope photograph presented in FIG. 7 shows some exemplary binder fibers of the present invention, in this instance having a diameter between 0.01 and 0.5 micrometers and a length slightly greater than 1 micrometer.

As a result of the contact of the cathode active material particles and the conductive substance particles, a lithium secondary battery including the cathode composition of this invention has an exceptionally high charge-discharge rate capability, power density and energy density. Power density is in this regard understood to be a measure of the discharge rate capability of the battery and is expressed in terms of watts per kilogram, while energy density is a measure of the total energy in a battery expressed in terms of watt-hours per kilogram.

The binder fibers that can be utilized in the cathode compositions of this invention include, but are not limited to, those made from polytetrafluoroethylene materials, from a polyvinylidene fluoride, polyethylene oxide, a tetrafluoroethylene copolymer, a vinylidene fluoride copolymer, the thermoplastic polyimides and polyvinylidene chlorides. Of these, polytetrafluoroethylene is preferred for the binder fibers. A commercially available polytetrafluoroethylene which is particularly suitable for preparing the binder fibers can be obtained from DuPont Fluoroproducts of Wilmington, Del., under the trade designation “TEFLON® PTFE 60”, as a white powder composed of agglomerate particles. The binder utilized is included in the cathode composition in an amount in the range of from about 1% to about 10%, more preferably in an amount of about 3 to about 5% by weight of the cathode composition.

The particulate cathode active materials that can be utilized in the cathode compositions of this invention include, but are not limited to, lithium cobalt dioxide, lithium nickel dioxide, lithium manganese oxide, lithium aluminum manganese dioxide, lithium vanadium oxide and mixtures and derivatives thereof. Of these, lithium aluminum manganese oxide is preferred. The particulate cathode active material is included in the cathode composition in an amount in the range of from about 80% to about 95%, more preferably in an amount of about 87% by weight of the cathode composition.

The particulate conductive substances that can be utilized in the cathode compositions of this invention include, but are not limited to, carbon black, graphite, metal particles and conjugated conductive polymers doped with an electron-donating or electron-attracting compound. Examples of such polymers include, but are not limited to polyacetylene, poly-p-phenylene, polypyrrole and polyaniline. Of the various particulate conductive substances that can be used, carbon black, graphite and mixtures of carbon black and graphite are the most preferred. A particularly suitable particulate conductive substance is a mixture of acetylene black and graphite, having a weight ratio of acetylene black to graphite in the range of from about 2:8 to about 8:2. The most preferred conductive substance is a mixture of equal parts by weight of acetylene black and graphite. The use of a mixture of acetylene carbon black and graphite as the conductive substance maximizes the conductivity of the cathode composition while utilizing a minimum amount of the conductive substance. The conductivity of the cathode composition depends on the conductivity of the conductive substance and the degree of its dispersion between the particles of cathode active material in the cathode composition. The mixture of acetylene black and graphite utilized in accordance with this invention is highly conductive and highly dispersed in the cathode composition, i.e., the graphite is highly conductive and the acetylene black is not as conductive, but it has a larger surface area and is more dispersed in the cathode composition than the graphite. The particulate conductive substance is included in the cathode composition in an amount in the range of from about 2% to about 15% by weight of the cathode composition, more preferably in an amount of about 8 to about 10% by weight of the cathode composition.

An especially preferred cathode of this invention for a lithium secondary battery is comprised of the cathode composition described above in contact with a current collector of aluminum foil. Thus, a lithium aluminum manganese oxide particulate cathode active material is provided in the cathode composition in an amount of about 87% by weight of the composition, a particulate conductive substance comprised of a mixture of equal parts by weight of acetylene black and graphite is present in an amount of about 8 to about 10% by weight of the composition and a binder comprised of polytetrafluoroethylene is present in an amount of about 3 to about 5% by weight of said composition. The binder is comprised of small fibers that are substantially homogeneously dispersed throughout the cathode composition, and which preferably substantially all have a diameter in the range of from about 0.01 micrometers to about 0.5 micrometers and a length in the range of from about 1 micrometers to about 10000 micrometers, while the aluminum foil current collector is preferably about 25 micrometers thick. Those skilled in the art will appreciate that with different combinations of active materials the performance characteristics in a lithium secondary battery will vary, but as demonstrated by the examples that follow, for this especially preferred cathode the binder fibers are sufficiently well dispersed and non-occlusive that a capacity retention at 16C of at least about 75 percent, and preferably at least about 85 percent of the capacity at C/3.5 is realized. Expressed in terms of the degree of improvement enabled over the prior, organic solvent-based slurry method, for the same particulate cathode active, conductive and binder materials in the same dry percentages, the process of the present invention (as described more particularly in several paragraphs following) preferably enables at least a doubling of the capacity retention at 16C as compared to at C/3.5 for lithium secondary batteries incorporating cathodes made by the respective slurry and inventive paste methods, and preferably at least a tripling of the capacity retention of such batteries.

An improved process for producing a cathode comprised of a current collector and a cathode composition including a particulate cathode active material, a particulate conductive substance and a binder formed of small fibers that are substantially homogeneously dispersed throughout the cathode composition, and wherein the cathode active material particles and the conductive substance particles are in contact with each other and with other adjacent battery parts in contact with the cathode composition, comprises the initial steps of dry mixing the cathode active material particles and the conductive substance particles with a binder fiber precursor (preferably in a particulate form, as exemplified by the TEFLON® PTFE 60 material mentioned previously) which cold flows under pressure, to form a paste. Thereafter, the paste is formed into a pressed layer corresponding to the cathode composition and then the pressed layer placed in contact with the current collector, all at a temperature below the melting point of the binder. In a more preferred process, the paste is directly formed into a pressed layer on the current collector, at a temperature below the melting point of the binder. As mentioned above in connection with the cathode of this invention, the particulate cathode active material is preferably lithium aluminum manganese oxide and the particulate conductive substance is preferably a mixture of equal parts by weight of acetylene black and graphite. The binder is preferably polytetrafluoroethylene and the current collector is preferably formed of aluminum foil.

The present invention also provides an improved lithium secondary battery comprised of a cathode, an anode and an electrolyte. The cathode is comprised of the above described cathode composition and a current collector in contact therewith. As indicated above, when the cathode is utilized in a lithium secondary battery, the battery has an improved charge-discharge rate capability as well as improved power and energy densities.

The anode of the lithium secondary battery can be formed of a carbonaceous material which can optionally be doped with lithium ions. The carbonaceous material can be a graphite material such as natural graphite or artificial graphite. A graphite anode is preferred because in combination with the cathode composition of this invention, a high energy density is provided.

Examples of non-aqueous liquid electrolytes that can be utilized in the lithium secondary battery of this invention are electrolytes comprised of an inorganic salt dissolved in an organic solvent. Examples of the inorganic salts which are suitable for use for ion transfer in a lithium secondary battery include, but are not limited to, LiClO₄, LiI, LiSCN, LiB₄, LiAsF₆, LiCF₃SO₃, LiPF₆, NaI, NaSCN, KI and CsSCN. Of these, LiPF₆ and LiCF₃SO₃ are preferred. Examples of the non-aqueous solvents which can be utilized include, but are not limited to, cyclic carbonates such as ethylene carbonate, propylene carbonate and butylene carbonate; acyclic carbonates such as dimethyl carbonate, diethyl carbonate and ethylmethylcarbonate; aliphatic carboxylic esters such as methyl formate, methyl acetate, methyl propionate and ethyl propionate; γ-lactones such as γ-butyrolactone; chain structure ethers such as 1,2-dimethoxyethane, 1,2-diethoxyethane and ethoxymethoxyethane; and cyclic ethers such as tetrahydrofuran, 2-methyltetrahydrofuran and the like. The solvents can be used alone or in mixtures. Of the various solvents, a mixture of ethylene carbonate and dimethyl carbonate in a weight ratio of 1:1 is preferred.

Examples of solid electrolytes which can be used are polymers that contain metal salts. Examples of the polymers that can be utilized include polyethers, polyesters, polyimides, cross-linked polyethers, polymers containing polyether segments, polymers of vinylsilane having alkoxy groups, polymethyl siloxanes having ethyleneoxide groups therein, polyphosphazenes having ethyleneoxy groups therein, polymethacrylic acid esters having ethyleneoxy groups therein, polyacrylic acid, polyaziridine, polyethylene sulfide and other polar polymer substances. Examples of various metal salts which can be included in the polymers include LiCIO₄, LiCF₃SO₃, LiF, NaI, LiI, NaSCN, LiBF₄, LiPF₆, LiBPh₄ (where Ph designates a phenyl group), alkali metal salts, sulfuric acid, phosphoric acid, trifluoromethanesulfonic acid, tetrafluoroethylenesulfonic acid and other proton acids. Of these, LiPF₆ and LiCF₃SO₃ are preferred. Polymeric gels that include electrolytes, i.e., the various metal salts listed above, can also be utilized.

A preferred lithium secondary battery of this invention is in sum comprised of: a cathode comprised of a cathode composition and an aluminum foil current collector in contact therewith, the cathode composition comprising a lithium manganese aluminum oxide particulate cathode active material present in an amount of about 87% by weight of the composition, a particulate conductive substance comprised of a mixture of acetylene black and graphite present in an amount of about 8 to about 10% by weight of the composition and a binder comprised of polytetrafluoroethylene present in an amount of about 3 to about 5% by weight of the composition, the binder in turn being comprised of small fibers that are substantially homogeneously dispersed throughout the cathode composition; an anode formed of graphite; and a non-aqueous electrolyte comprised of a liquid mixture of ethylene carbonate and dimethyl carbonate in a weight ratio of 1:1 having lithium hexafluorophosphate salt therein.

In order to further illustrate the cathode compositions, methods and lithium secondary batteries of this invention, the following examples are given.

### COMPARATIVE EXAMPLE 1

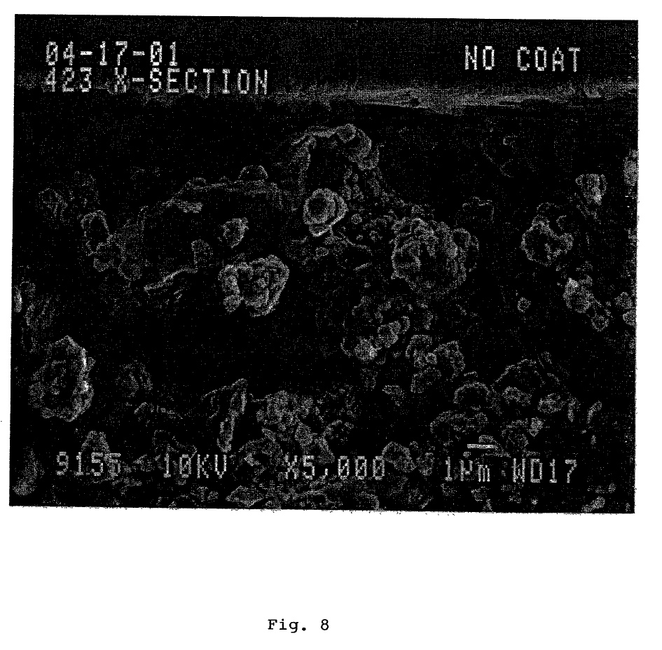

Utilizing conventional methods, a prior art cathode was prepared comprised of a lithium manganese oxide particulate cathode material, a carbon particulate conductive substance and a polyvinylidene fluoride binder dissolved in N-methylpyrrolidone solvent. The mixture was formed into a uniform slurry in which the lithium manganese oxide particles and carbon particles were suspended. The slurry was spread to a uniform thickness on the surface of an aluminum foil current collector and the N-methylpyrrolidone solvent was evaporated at an elevated temperature. The non-conductive polyvinylidene fluoride was observed to be interposed between the lithium manganese oxide and carbon particles in the form of sheets. Most significantly, the non-conductive polyvinylidene fluoride formed an insulating sheet between the cathode composition and the current collector. This phenomenon is evidence by the Scanning Electron Micrograph presented in FIG. 8.

### EXAMPLE 1

Using the method of the present invention, a cathode active material, comprised of lithium aluminum manganese oxide (Li_{1.05}Al_{0.27}Mn_{1.68}O₄) was blended with a conductive substance comprised of a mixture of acetylene black and graphite and a binder comprised of polytetrafluoroethylene in a weight ratio of 87 parts Li_{1.05}Al_{0.27}Mm_{1.68}O₄:5 parts acetylene black:5 parts graphite and 3 parts polytetrafluoroethylene. The acetylene black utilized is commercially available from Denki Kagaku Kogyo Kabushiki Kaisha of Tokyo, Japan under the trade designation “DENKA™” acetylene black. The graphite utilized is commercially available from TIMCAL Ltd. of Sins, Switzerland under the trade designation “TIMCAL™ KS-6” graphite, and the polytetrafluoroethylene utilized is commercially available from DuPont Fluoroproducts of Wilmington, Del. under the trade designation “TEFLON® PTFE 60.” As mentioned above, the graphite conductive substance is more conductive than acetylene black and the acetylene black has a larger surface area and is more dispersed in the electrode than is the graphite.

The components of the cathode composition were ground thoroughly using a mortar and pestle for 20 minutes to form a uniform paste. Next, the rubber-like cathode paste was roll pressed into a thin sheet having a thickness of about 50 micrometers on an aluminum foil current collector sheet having a thickness of about 25 micrometers. Circular cathodes were punched out with a 0.5′ diameter punch and each cathode was weighed. The mass of cathode mix on each cathode disc was about 14 milligrams which corresponded to about 12 milligrams of cathode active material and a cathode active material loading of about 10 milligrams per square centimeter.

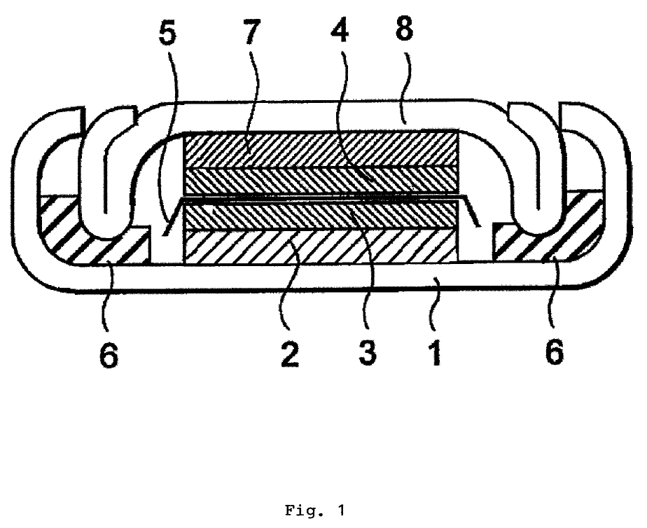

Referring to FIG. 1, a lithium secondary coin cell (battery) of the type used in the tests described in this and the following examples is illustrated. The coin cells were comprised of a stainless steel base container 1 having a cathode (2,3) positioned adjacent to the base container 1. The cathode was formed of aluminum foil current collector 2 and a cathode composition 3. A separator 5 was positioned adjacent to the cathode composition 3. The separator 5 was formed of a sheet of polypropylene and polyethylene resins commercially available from Celguard, LLC of Charlotte, N.C. under the trade designation “CELGUARD™ 3501.” An anode 4 formed of lithium was positioned above and adjacent to the separator 5 and a stainless steel spacer 7 was positioned adjacent to the anode 4. A seal ring 6 was placed within the stainless steel base container 1 and a stainless steel top 8 was positioned above the stainless steel spacer 7. Prior to placing the lithium anode 4, stainless steel spacer 7 and stainless steel top 8 on the separator 5, four to five drops of electrolyte were placed on the separator 5 whereby the separator 5 was thoroughly soaked with the electrolyte. The electrolyte used was comprised of lithium hexafluorophosphate in a 1:1 by weight mixture of ethylene carbonate and dimethyl carbonate. The top 8 was aligned within the stainless steel base container 1 in contact with the seal ring 6 and the base container 1 was crimped to hold the top 8.

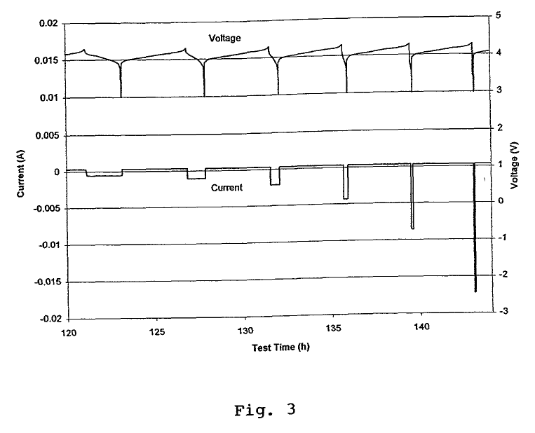

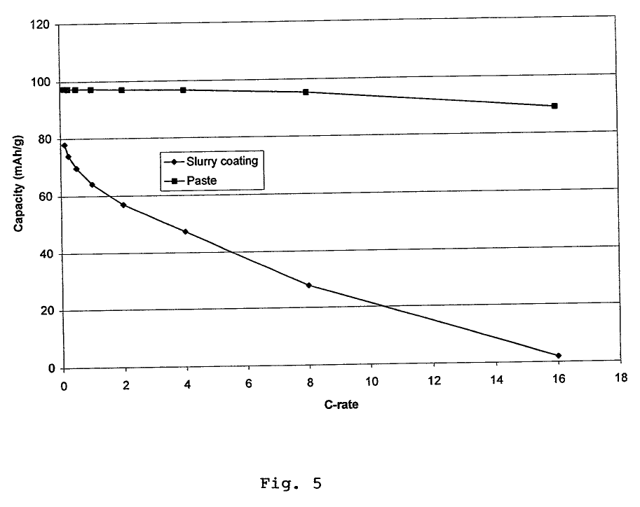

A number of assembled coin cells were produced as described above which were electrochemically cycled on an Arbin tester at ambient temperature. The Arbin tester was built and distributed by Arbin Instruments of College Station, Tex. The test procedure was as follows: (A) Initially, the cells were cycled between 3 to 4.3 volts at a rate of C/3.5 for 5 to 15 cycles. The capacity used for calculating the C-rate is 100 mAh/g. (B) Then the cells were charged at a rate of C/3.5 and discharged at the rates of C/8, C/4, C/2, C, 2C, 4C, 8C and 16C, respectively, after each charge, for a total of 8 charge-discharge cycles. The letter C is used above to mean C-rate which is defined as a value of discharge current that releases in 1 hour the total capacity that is determined based on 100 mAh/g for spinel cathode active materials. The current and voltage profiles for the above described measurements are shown in FIG. 3. The results of the tests described above are shown in the graph presented in FIG. 5 by the “paste” curve. As shown by the paste curve, the capacity retention at 16C is 90% of that at C/3.5.

### COMPARATIVE EXAMPLE 2

Using the prior art slurry coating method, 10 grams of polyvinylidene fluoride powder were dissolved in 90 grams of N-methyl-2-pyrrolidone to form a uniform solution by leaving a sealed glass bottle of the solution in an oven at 50° C. for 12 hours. A slurry was then assembled using 3 grams of lithium aluminum manganese oxide (Li_{1.05}Al_{0.27}Mn_{1.68}O₄), together with amounts of “TIMCAL™ KS-6” graphite, “DENKA™” acetylene black and polyvinylidene fluoride in the NMP solution to provide a dry weight ratio (excluding the N-methyl-2-pyrrolidone) of 87 parts Li_{1.05}Al_{0.27}Mn_{1.68}O₄:5 parts acetylene black carbon:5 parts graphite and 3 parts polyvinylidene fluoride.

In assembling the slurry, the lithium aluminum manganese oxide and the conductive substance comprised of graphite and carbon were initially mixed thoroughly using a hand blender. Second, a solution of polyvinylidene fluoride with the N-methyl-2-pyrrolidone was added to the powdered mix, with additional NMP being added to yield a mixture which was 40% by weight of solids. The mix was then blended in a small glass bottle for twelve hours using a Turbula mixer obtained from Glen Mills, Inc. of Clifton, N.J., so that a uniform slurry was developed.

In a ventilated hood, a battery-grade aluminum foil having a thickness of about 25 micrometers was smoothed on the surface of a vacuum plate. The aluminum foil was wiped with a paper towel soaked with acetone to remove contaminants on the aluminum foil surface. A portion of the slurry described above was poured onto the aluminum foil. A coater with an adjustable gap of 50 to 100 micrometers was used to spread the slurry and form a uniform layer on the aluminum foil. The coating was then dried at 80° C. for 2 hours to evaporate the N-methyl-2-pyrrolidone solvent. The thickness of the coating was then measured and cathodes were prepared and tested in the same manner as described above in Example 1. The results of these tests of cathodes prepared using the slurry coating method are shown by the curve marked “slurry coating” in the graph presented in FIG. 5. As shown in the graph, the capacity retention at 16C was 2% of the capacity at C/3.5.

### EXAMPLE 2

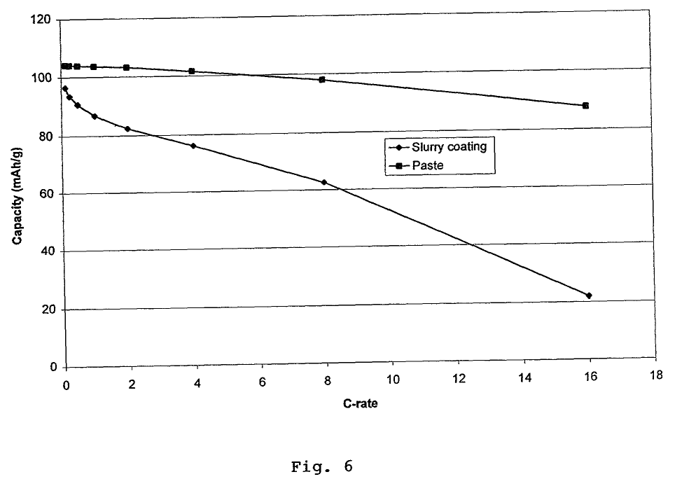

Using the paste method of the present invention, 0.4 grams of lithium aluminum manganese oxide (Li_{1.04}Al_{0.23}Mn_{1.73}O₄) was blended with “TIMCAL™ KS-6” graphite, “DENKA™” acetylene black and “TEFLON®” polytetrafluoroethylene in a weight ratio of 87:5:5:3. Cathodes were prepared as described in Example 1, installed in a number of test coin cells and the cells were tested in the same manner as described in Example 1. The results of the tests are shown in the graph presented in FIG. 6 by the curve identified as “paste.” The capacity retention at 16C was 85% of that at C/3.5.

### COMPARATIVE EXAMPLE 3

3 grams of lithium aluminum manganese oxide (Li_{1.04}Al_{0.23}Mn_{1.73}O₄) was mixed with “TIMCAL™ KS-6” graphite, “DENKA™” acetylene black and “TEFLON®” polytetrafluoroethylene from solution in NMP in a dry weight ratio (excluding the N-methyl-2-pyrrolidone) in a weight ratio of 87:5:5:3. Cathodes and test coin cell batteries were prepared, respectively, in the same manner as described in Comparative Example 2 and Example 1 above. The results of the tests are shown in the graph presented in FIG. 6 and the curve thereon marked “slurry coating.” The results of the tests show that the capacity retention at 16C was 21% of the capacity at C/3.5.

### EXAMPLE 3

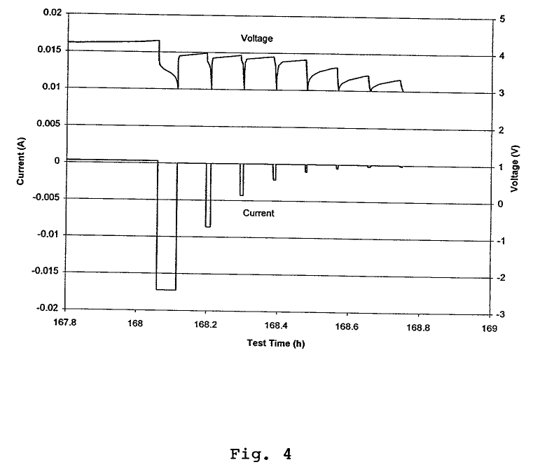

Cathodes and coin cell batteries were prepared in accordance with the present invention as described in Example 1. However, the electrochemical test procedure utilized in this example is different than the test procedure utilized in Example 1. That is, after each test as described in Example 1, the cells being tested were cycled between 3 to 4.3 volts at a rate of C/3.5 for 5 cycles, then the cells were charged at C/3.5 and discharged at the rates of 16C, 8C, 4C, 2C, C, C/2, C/4 and C/8 consecutively with a rest of 5 minutes between each discharge. Stated differently, one charge process was followed by the discharge processes at varied C-rates with rests between the different discharge rates. This procedure is referred to herein as the “relaxation method.” The current and voltage profiles of the relaxation method tests are shown in FIG. 4. The tests results are the same as those produced in Example 1 and shown in FIG. 5 by the curve designated “paste.”

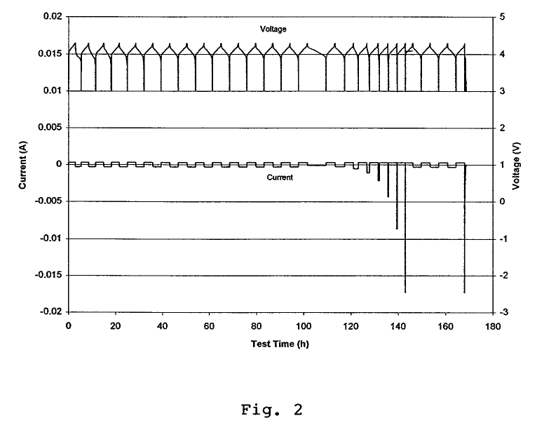

FIG. 2 is a presentation of the total regime for testing the coin cells by presenting the current and voltage profiles for testing the charge-discharge rate capability of the coin cells tested.

As has been demonstrated, the present invention is well adapted to carry out the objects and advantages mentioned as well as those which are inherent therein. While numerous changes can be made by those skilled in the art, such changes are encompassed within the spirit of this invention as defined by the appended claims.

What is claimed is:

1. A cathode composition for a lithium secondary battery comprising a particulate cathode active material, a particulate conductive substance and a binder formed of small fibers that are substantially homogeneously dispersed throughout said cathode composition but which do not encapsulate to any meaningful degree the particulate conductive substance and cathode active materials.

2. The cathode composition of claim 1 wherein substantially all of said fibers of said binder have a diameter in the range of from about 0.01 micron to about 0.5 micron and a length in the range of from about 1 micrometers to about 10000 micrometers.

3. The cathode composition of claim 1 wherein said binder fibers are formed from a material selected from the group consisting of polytetrafluoroethylene, polyvinylidene fluoride, polyethylene oxide, tetrafluoroethylene copolymer, vinylidene fluoride copolymer, thermoplastic polyimide and polyvinylidene chloride.

4. The cathode composition of claim 1 wherein said binder fibers are formed from polytetrafluoroethylene.

5. The cathode composition of claim 1 wherein said binder fibers are present in an amount in the range of from about 1% to about 10% by weight of said cathode composition.

6. The cathode composition of claim 1 wherein said particulate cathode active material is selected from the group consisting of lithium cobalt dioxide, lithium nickel dioxide, lithium manganese oxide, lithium aluminum manganese oxide, lithium vanadium oxide and mixtures and derivatives thereof.

7. The cathode composition of claim 1 wherein said particulate cathode active material is lithium aluminum manganese oxide.

8. The cathode composition of claim 1 wherein said particulate cathode active material is present in an amount in the range of from about 80% to about 95% by weight of said cathode composition.

9. The cathode composition of claim 1 wherein said particulate conductive substance is selected from the group consisting of carbon, graphite and metal particles.

10. The cathode composition of claim 1 wherein said particulate conductive substance is selected from the group of conjugated conductive polymers doped with an electron-donating or electron-attracting compound consisting of polyacetylene, poly-p-phenylene, polypyrrole and polyaniline.

11. The cathode composition of claim 1 wherein said particulate conductive substance is a mixture of acetylene black carbon and graphite having a weight ratio of acetylene black carbon to graphite in the range of from about 2:8 to about 8:2.

12. The cathode composition of claim 1 wherein said particulate conductive substance is present in an amount in the range of from about 2% to about 15% by weight of said cathode composition.

13. The cathode composition of claim 1 which is formed on an aluminum foil current collector.

14. A cathode for a lithium secondary battery comprised of:
a cathode composition comprising a lithium aluminum manganese oxide particulate cathode active material present in an amount of about 87% by weight of said composition, a particulate conductive substance comprised of a mixture of acetylene black carbon and graphite present in an amount of about 8% to about 10% by weight of said composition and a binder comprised of polytetrafluoroethylene present in an amount of about 3% to about 5% by weight of said composition, said binder having small fibers that are substantially homogeneously dispersed throughout said cathode composition; and
an aluminum foil current collector.

15. The cathode of claim 14 wherein said mixture of acetylene black carbon and graphite has a weight ratio of acetylene black carbon to graphite of 1:1.

16. The cathode of claim 14 wherein substantially all of said fibers of said binder have a diameter in the range of from about 0.01 micrometers to about 0.5 micrometers and a length in the range of from about 1 micrometers to about 10000 micrometers.

17. A process for producing a cathode for a lithium secondary battery comprised of a current collector and a cathode composition, the cathode composition comprising a particulate cathode active material, a particulate conductive substance and a binder formed of small fibers that are substantially homogeneously dispersed throughout the cathode composition, wherein the process comprises:
dry mixing said cathode active material particles and said conductive substance particles with a fiber binder precursor that cold flows under pressure, to thereby form a paste; and
forming said paste into a pressed layer comprised of the cathode composition and placing the layer in contact with said current collector, all at a temperature below the melting point of the binder.

18. The process of claim 17 wherein said current collector is formed of aluminum and said paste is formed into a pressed layer on said current collector at a temperature below the melting point of said binder.

19. The process of claim 17 wherein substantially all of said fibers of said binder have a diameter in the range of from about 0.01 micrometer to about 0.5 micrometer and a length in the range of from about 1 micrometers to about 10,000 micrometers.

20. The process of claim 17 wherein said binder fibers are formed from a material selected from the group consisting of polytetrafluoroethylene, polyvinylidene fluoride, polyethylene oxide, tetrafluoroethylene copolymer, vinylidene fluoride copolymer, thermoplastic polyimide and polyvinylidene chloride.

21. The process of claim 17 wherein said binder fibers are formed from polytetrafluoroethylene.

22. The process of claim 17 wherein said binder fibers are present in an amount in the range of from about 1% to about 10% by weight of said cathode composition.

23. The process of claim 17 wherein said particulate cathode active material is selected from the group consisting of lithium cobalt dioxide, lithium nickel dioxide, lithium manganese oxide, lithium aluminum manganese oxide, lithium vanadium oxide and mixtures thereof.

24. The process of claim 17 wherein said particulate cathode active material is lithium aluminum manganese oxide.

25. The process of claim 17 wherein said particulate cathode active material is present in an amount in the range of from about 80% to about 95% by weight of said cathode composition.

26. The process of claim 17 wherein said particulate conductive substance is selected from the group consisting of carbon, graphite and metal particles.

27. The process of claim 17 wherein said particulate conductive substance is selected from the group of conjugated conductive polymers doped with an electron-donating or electron-attracting compound consisting of polyacetylene, poly-p-phenylene, polypyrrole and polyaniline.

28. The process of claim 17 wherein said particulate conductive substance is a mixture of acetylene black carbon and graphite having a weight ratio of acetylene black carbon to graphite in the range of from about 2:8 to about 8:2.

29. The process of claim 17 wherein said particulate conductive substance is present in an amount in the range of from about 2% to about 15% by weight of said cathode composition.

30. A lithium secondary battery comprising:
a cathode comprised of a cathode composition and a current collector m contact therewith, said cathode composition comprising a particulate cathode active material, a particulate conductive substance and a binder formed of small fibers that are substantially homogeneously dispersed throughout said cathode composition but which do not encapsulate to any meaningful degree the particulate conductive substance and cathode active materials;
an anode formed of a carbonaceous material that can be doped or undoped with lithium ions, a lithium metal or a lithium alloy; and
a non-aqueous liquid or solid electrolyte.

31. The lithium secondary battery of claim 30 wherein substantially all of said fibers of said binder have a diameter in the range of from about 0.01 micrometer to about 0.5 micrometer and a length in the range of from about 1 micrometers to about 10,000 micrometers.

32. The lithium secondary battery of claim 30 wherein said binder fibers are formed from a material selected from the group consisting of polytetrafluoroethylene, polyvinylidene fluoride, polyethylene oxide, tetrafluoroethylene copolymer, vinylidene fluoride copolymer, thermoplastic polyimide and polyvinylidene chloride.

33. The lithium secondary battery of claim 30 wherein said binder fibers are formed from polytetrafluoroethylene.

34. The lithium secondary battery of claim 30 wherein said binder fibers are present in an amount in the range of from about 80% to about 95% by weight of said cathode composition.

35. The lithium secondary battery of claim 30 wherein said particulate cathode active material is selected from the group consisting of lithium cobalt dioxide, lithium nickel dioxide, lithium manganese oxide, lithium aluminum manganese oxide, lithium vanadium oxide and mixtures and derivatives thereof.

36. The lithium secondary battery of claim 30 wherein said particulate cathode active material is lithium aluminum manganese oxide.

37. The lithium secondary battery of claim 30 wherein said particulate cathode active material is present in an amount in the range of from about 80% to about 95% by weight of said cathode composition.

38. The lithium secondary battery of claim 30 wherein said particulate conductive substance is selected from the group consisting of carbon, graphite and metal particles.

39. The lithium secondary battery of claim 30 wherein said particulate conductive substance is selected from the group of conjugated conductive polymers doped with an electron-donating or electron-attracting compound consisting of polyacetylene, poly-p-phenylene, polypyrrole and polyaniline.

40. The lithium secondary battery of claim 30 wherein said particulate conductive substance is a mixture of acetylene black carbon and graphite having a weight ratio of acetylene black carbon to graphite in the range of from about 2:8 to about 8:2.

41. The lithium secondary battery of claim 30 wherein said particulate conductive substance is present in an amount in the range of from about 2% to about 15% by weight of said cathode composition.

42. The lithium secondary battery of claim 30 wherein said current collector is formed of aluminum foil.

43. The lithium secondary battery of claim 30 wherein said anode is lithium metal.

44. The lithium secondary battery of claim 30 wherein said electrolyte is comprised of an inorganic salt dissolved in an organic liquid selected from the group consisting of ethylene carbonate, dimethyl carbonate, propylene carbonate and mixtures thereof.

45. The lithium secondary battery of claim 44, wherein the inorganic salt is LiPF₆ or LiCF₃SO₃.

46. The lithium secondary battery of claim 30 wherein said electrolyte is comprised of solid polymers that contain salts selected from the group consisting of LiPF₆, LiCF₃SO₃ and LiCIO₄.
